(19) United States
(12) Patent Application Publication
(10) Pub. No.: US 2022/0075048 A1
(43) Pub. Date: Mar. 10, 2022

(54) THREE-DIMENSIONAL POSITIONING METHOD AND APPARATUS

(71) Applicant: DENSO CORPORATION, Kariya-city (JP)

(72) Inventors: Masakazu IKEDA, Nisshin-city (JP); Mitsutoshi MORINAGA, Kariya-city (JP)

(21) Appl. No.: 17/455,832

(22) Filed: Nov. 19, 2021

Related U.S. Application Data
(63) Continuation of application No. PCT/JP2020/019005, filed on May 12, 2020.

(30) Foreign Application Priority Data
May 22, 2019 (JP) 2019-096062

(51) Int. Cl. G01S 13/46; G01S 13/931

(52) U.S. Cl. CPC G01S 13/46; G01S 2013/466; G01S 13/931

(57) ABSTRACT

A grouping unit separates, into groups, reflection points included in plural sets of reflection-point information items based on positional parameters of the respective reflection points in a first direction. Each of the positional parameters of a corresponding one of the reflection points in the first direction represents a position of the corresponding one of the reflection points in the first direction. A measuring unit performs a two-dimensional trilateration localization for each of the groups based on at least one reflection point included in a corresponding one of the groups to thereby calculate a location of the at least one reflection point included in each of the groups in a second plane. The second plane is defined by the second direction and a group center direction of the corresponding one of the groups.

### CROSS-REFERENCE TO RELATED APPLICATION

The present application is a bypass continuation application of currently pending international application No. PCT/JP2020/019005 filed on May 12, 2020 designating the United States of America, the entire disclosure of which is incorporated herein by reference.

The present application is based on and claims the benefit of priority from Japanese Patent Application No. 2019-096062 filed on May 22, 2019, the entire disclosure of which is incorporated herein by reference.

### TECHNICAL FIELD

The present disclosure relates to technologies for measuring three-dimensional positions of target points.

### BACKGROUND

A well-known cruise-assist control task is activated to

1. Detect various target objects using a range sensor, i.e., a distance measuring sensor, installed in an own vehicle

2. Activate a brake system and/or issue a warning in response to determination that at least one detected target object, which is another vehicle or an obstacle, has a possibility of colliding with the own vehicle

### SUMMARY

A three-dimensional positioning apparatus according to an exemplary aspect of the present disclosure includes a grouping unit configured to separate, into groups, reflection points included in plural sets of reflection-point information items based on positional parameters of the respective reflection points in a first direction. Each of the positional parameters of a corresponding one of the reflection points in the first direction represents a position of the corresponding one of the reflection points in the first direction. The three-dimensional positioning apparatus includes a measuring unit configured to perform a two-dimensional trilateration localization for each of the groups based on at least one reflection point included in a corresponding one of the groups to thereby calculate a location of the at least one reflection point included in each of the groups in a second plane. The second plane is defined by the second direction and a group center direction of the corresponding one of the groups.

### BRIEF DESCRIPTION OF THE DRAWINGS

FIG. 1 is a block diagram illustrating a configuration of a three-dimensional positioning apparatus according to the first embodiment.

FIG. 2 is a view illustrating how a sensor unit is arranged according to the first embodiment;

FIG. 3 is view illustrating reflection points in an X-Z plane;

FIG. 4 is a view illustrating, on the X-Z plane, a result of a two-dimensional TOA localization carried out for each group of reflection-point information items;

FIG. 5 is a view illustrating, on an X-Y plane, a result of the two-dimensional TOA localization carried out for each group of reflection-point information items;

FIG. 6 is a view illustrating, on the X-Y plane, a result of the two-dimensional TOA localization carried out collectively for ungrouped reflection-point information items;

FIG. 7 is a table illustrating a roughly estimated calculation time of each of a usual two-dimensional TOA localization, a usual three-dimensional TOA localization, and the two-dimensional TOA localization carried out for each group of reflection-point information items;

FIG. 8 is a block diagram illustrating a configuration of a three-dimensional positioning apparatus according to the second embodiment.

FIG. 9 is a view illustrating how a sensor unit is arranged according to the second embodiment;

FIG. 10 is a view illustrating how the location of a range sensor travels as a vehicle travels;

FIG. 11 is a block diagram illustrating a grouping unit according to the third embodiment;

FIG. 12 is a view illustrating the principle of the two-dimensional TOA localization;

FIG. 13 is a view illustrating the principle of the three-dimensional TOA localization; and

FIG. 14 is a view illustrating an error due to execution of the two-dimensional trilateration localization for three-dimensionally distributed reflection points.

### DETAILED DESCRIPTION OF EMBODIMENTS

### Focusing Points

Even if there is a detected target object at a location through which a predicted route of an own vehicle is predicted to pass, such a cruise-assist control task described above need be maintained in an inactive condition in response to determination that the detected target object is either a superjacent object under which the own vehicle can pass, such as a signboard or a tunnel roof, or a subjacent object over which the own vehicle can pass, such as a manhole.

For avoidance of erroneous activation of the cruise-assist control task in response to determination that the detected target object is a superjacent object or a subjacent object, three-dimensional recognition of the position of a target object is required. The three-dimensional recognition of the position of a target object represents the recognition of the three-dimensional position of the target object in a horizontal plane and in a height direction perpendicular to the horizontal plane.

On the other hand, there are well-known methods of determining the positions of probe-wave reflection points, which will be referred to simply as reflection points, using at least two range sensors. One of these methods uses a trilateration technology, such as a Time Of Arrival (TOA) localization or a Time Difference Of Arrival (TDOA) localization.

The TOA localization is designed to perform, for each reflection point, the following task of

1. Measuring a distance of the corresponding reflection point from a first range sensor, i.e., an arrival time of a probe wave emitted from the first range sensor at the corresponding reflection point

2. Measuring a distance of the corresponding reflection point from a second range sensor, i.e., an arrival time of a probe wave emitted from the second range sensor at the corresponding reflection point

3. Create a first circle that has, as its radius, the measured distance about the first range sensor

4. Create a second circle that has, as its radius, the measured distance about the second range sensor

5. Calculate a point of intersection between the first circle and the second circle as the corresponding reflection point

The TDOA localization is designed to perform, for each reflection point, the following task of

1. Measuring a difference in distance of the corresponding reflection point between each pair of plural range sensors, i.e., a difference between arrival times of probe waves at the corresponding reflection point emitted from each pair of range sensors

2. Create, based on the measured difference in distance for each pair of plural range sensors, a hyperboloid whose focal points are the locations of the corresponding pair of range sensors

3. Determine the location of the corresponding reflection point based on the hyperboloid for each pair of plural range sensors

The following describes determination of the three-dimensional position (location) of a reflection point using, as an example, the TOA localization.

The TOA localization uses distances of each reflection point measured by the respective distance sensors; each of the distances represents a distance from the corresponding reflection point to the corresponding one of the range sensors. Next, the TOA localization randomly selects pairs of the measured distances of each reflection point to thereby generate measurement values of each reflection point based on the respective pairs of the distances of the corresponding reflection point. Then, the TOA localization extracts, from the generated measurement values of each refection point, a selected measurement value that represents the location of the corresponding reflection point.

When measuring the two-dimensional location of each reflection point, the TOA localization creates a circle that has, as its radius, the measured distance of the corresponding reflection point about each of two range sensors, and calculates points of intersection among the created circles of each reflection point as the respective measurement values of the corresponding reflection point.

When measuring the three-dimensional location of each reflection point, the TOA localization creates a circle that has, as its radius, the measured distance of the corresponding reflection point about each of three range sensors, and calculates points of intersection among the created circles of each reflection point as the respective measurement values of the corresponding reflection point.

As clearly seen by comparison between the TOA localization for measuring the three-dimensional location of each reflection point and that for measuring the two-dimensional location of each reflection point, the TOA localization for measuring the three-dimensional location of each reflection point makes a calculation process more complicated; the calculation process calculates the points of intersection among the created circles of the corresponding reflection point as the respective measurement values of the corresponding reflection point.

An increase in the number of distances of reflection points measured by respective range sensors increases the number of measurement values of the reflection points, i.e., the number of points of intersection among the created circles of the reflection points, resulting in the time required to complicate the calculation process becoming excessive.

From this viewpoint, Japanese Patent Application Publication No. 2017-142164 discloses a technology that classifies measurement values of reflection points into plural clusters based on doppler velocities of the respective measurement values, and calculates a three-dimensional location for each of the clusters.

As a result of detailed consideration of the technology disclosed in the patent publication, the inventors of the present disclosure have found out the following problem.

The above technology disclosed in the patent publication, which calculates the three-dimensional location for each of the clusters, may result in a smaller throughput of calculating the three-dimensional location for each of the clusters, because the number of points of intersection among created circles in each of the clusters becomes smaller.

The above technology disclosed in patent literature may unfortunately require execution of a complicated three-dimensional process for each of the clusters, resulting in insufficient reduction of the throughput of calculating the three-dimensional location for each of the clusters.

The present disclosure aims to provide a technology, which is capable of reducing the throughput required to perform three-dimensional measurement.

A first exemplary measure of the present disclosure provides a three-dimensional positioning apparatus. The three-dimensional positioning apparatus includes an information generating unit, a grouping unit, and a measuring unit.

The information generating unit is configured to generate plural sets of reflection-point information items using at least one range sensor. Each of the reflection-point information items of each of the plural sets includes a distance of a reflection point that reflects a probe wave signal emitted from the at least one range sensor, the distance being a distance of the reflection point from the at least one range sensor. Each of the reflection-point information items of each of the plural sets also includes an angle of the reflection point in a first plane, the angle of the reflection point representing an azimuth of the reflection point with respect to the at least one range sensor. The first plane is defined by a first direction and a bore sight direction that represents a direction of the probe wave signal emitted from the at least one range sensor. The first direction is perpendicular to the bore sight direction. The plural sets of reflection-point information items are measured by the at least one range sensor at respectively different positions in a second direction that is perpendicular to the first direction.

The grouping unit is configured to separate, into a plurality of groups, the reflection points included in the plural sets of reflection-point information items based on positional parameters of the respective reflection points in the first direction. Each of the positional parameters of a corresponding one of the reflection points in the first direction represents a position of the corresponding one of the reflection points in the first direction.

The measuring unit is configured to perform a two-dimensional trilateration localization for each of the groups based on at least one reflection point included in a corresponding one of the groups to thereby calculate a location of the at least one reflection point included in each of the groups in a second plane. The second plane is defined by the second direction and a group center direction of the corresponding one of the groups. The group center direction of each group represents a center of the corresponding group in the first direction.

A second exemplary measure of the present disclosure provides a three-dimensional positioning method to be carried out by a computer.

The three-dimensional positioning method includes generating plural sets of reflection-point information items using at least one range sensor. Each of the reflection-point information items of each of the plural sets includes a distance of a reflection point that reflects a probe wave signal emitted from the at least one range sensor, the distance being a distance of the reflection point from the at least one range sensor. Each of the reflection-point information items of each of the plural sets also includes an angle of the reflection point in a first plane, the angle of the reflection point representing an azimuth of the reflection point with respect to the at least one range sensor. The first plane is defined by a first direction and a bore sight direction that represents a direction of the probe wave signal emitted from the at least one range sensor. The first direction is perpendicular to the bore sight direction. The plural sets of reflection-point information items are measured by the at least one range sensor at respectively different positions in a second direction that is perpendicular to the first direction.

The three-dimensional positioning method includes separating, into a plurality of groups, the reflection points included in the plural sets of reflection-point information items based on positional parameters of the respective reflection points in the first direction. Each of the positional parameters of a corresponding one of the reflection points in the first direction represents a position of the corresponding one of the reflection points in the first direction.

The three-dimensional positioning method includes performing a two-dimensional trilateration localization for each of the groups based on at least one reflection point included in a corresponding one of the groups to thereby calculate a location of the at least one reflection point included in each of the groups in a second plane. The second plane is defined by the second direction and a group center direction of the corresponding one of the groups. The group center direction of each group represents a center of the corresponding group in the first direction.

Each of the first and second exemplary measures separates, into the plurality of groups, the reflection points included in the plural sets of reflection-point information items based on the positional parameters of the respective reflection points in the first direction. Each of the positional parameters of a corresponding one of the reflection points in the first direction represents the position of the corresponding one of the reflection points in the first direction.

Then, each of the first and second exemplary measures performs the two-dimensional trilateration localization for each of the groups.

This therefore results in the number of at least one reflection point included in each of the groups, which is subjected to the two-dimensional trilateration localization, being reduced, resulting in the number of measurement points represented by the number of combinations of the reflection points included in each of the groups being reduced. This accordingly makes it possible to reduce a processing time required to perform the two-dimensional trilateration localization based on the grouped reflection-point information items as compared with a processing time required to perform the two-dimensional trilateration localization based on all the reflection-point information items collectively without being grouped.

Each of the first and second exemplary measures enables the reflection points included in each of the groups to respectively have smaller differences in a direction perpendicular to the second plane. This accordingly results in a smaller error of the location of each of the three-dimensionally distributed reflection points due to execution of the two-dimensional trilateration localization for the three-dimensionally distributed reflection points.

### DETAILED DESCRIPTION OF EMBODIMENTS

The following describes exemplary embodiments of the present disclosure with reference to the accompanying drawings.

### Summary of TOA Location Technology

Before describing the exemplary embodiments of the present disclosure, the following describes the summary of the TOA localization, which is an example of a trilateration localization.

When determining the two-dimensional position (location) of each of first and second reflection points, the TOA localization, which will be referred to as a two-dimensional TOA localization, uses first and second range sensors S1 and S2 arranged at respectively different positions to

1. Measure, using the first range sensor S1, a distance of the first reflection point from the first range sensor S1

2. Measure, using the second range sensor S2, a distance of the first reflection point from the second range sensor S2

3. Measure, using the first range sensor S1, a distance of the second reflection point from the first range sensor S1

4. Measure, using the second range sensor S2, a distance of the second reflection point from the second range sensor S2

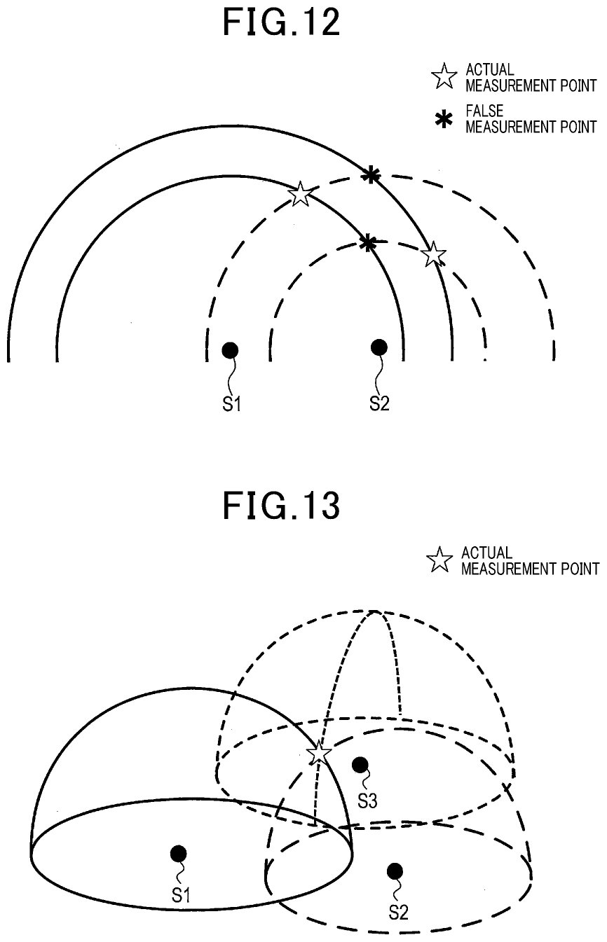

Then, as illustrated in FIG. 12, the two-dimensional TOA localization creates virtual circles, each of which has, as its radius, the corresponding one of the measured distances about the first range sensor S1, and creates virtual circles, each of which has, as its radius, the corresponding one of the measured distances about the second range sensor S2.

Next, the two-dimensional TOA localization performs the calculation process of calculating two-dimensional positions (locations) of respective points of intersection among the virtual circles as measurement values of the respective first and second reflection points.

When determining the three-dimensional position (location) of a reflection point, the TOA localization, which will be referred to as a three-dimensional TOA localization, uses first to third range sensors S1 to S3 arranged at respectively different positions to

1. Measure, using the first range sensor S1, a first distance of the reflection point from the first range sensor S1

2. Measure, using the second range sensor S2, a second distance of the reflection point from the second range sensor S2

3. Measure, using the third range sensor S3, a third distance of the reflection point from the third range sensor S3

Additionally, as illustrated in FIG. 13, the three-dimensional TOA localization creates a first virtual sphere that has, as its radius, the measured first distance about the first range sensor S1, and creates a second virtual sphere that has, as its radius, the measured second distance about the second range sensor S2. In addition, the three-dimensional TOA localization creates a third virtual sphere that has, as its radius, the measured third distance about the third range sensor S3.

Then, the three-dimensional TOA localization performs the calculation process of calculating a three-dimensional position (location) of a point of intersection between the first to third virtual spheres as a measurement value of the reflection point.

In particular, the two-dimensional TOA localization can calculate the two-dimensional position (location) of a point of intersection between a first virtual half circle and a second virtual half circle as a measurement value of a target point; each of the first and second virtual half circles around the corresponding one of the first and second ranging sensors S1 and S2 represents a probe-wave emission range of the corresponding one of the first and second ranging sensors S1 and S2.

Similarly, the three-dimensional TOA localization can calculate a three-dimensional position (location) of a point of intersection between first to third virtual half spheres as a measurement value of the target point; each of the first to third virtual half spheres around the corresponding one of the first to third ranging sensors S1 to S3 represents a probe-wave emission range of the corresponding one of the first to third ranging sensors S1 to S3.

The two-dimensional or three-dimensional TOA localization set forth above results in an increase in the number of points of intersection, i.e., the number of combinations of measured distances, with an increase in the number of reflection points (target points). Hereinafter, the number of points of intersections among measured distances will also be referred to as measurement points.

For example, FIG. 12 illustrates a case where each of the first and second ranging sensors S1 and S2 measures two distances for respective two reflection points (first and second reflection points), so that four measurement points are obtained among the four measured distances. In the four measurement points, two measurement points respectively represent the actual measurement points (actual images), and the remaining two measurement points respectively represent false measurement points, i.e., ghost measurement points (false images).

That is, measurement points obtained by the two-dimensional or three-dimensional TOA localization, which are subjected to the calculation process, do not show actual measurement points, but include one or more false measurement points. For example, if the number of actual measurement points is N, the number of measurement points, which are subjected to the calculation process, becomes N² for the two-dimensional TOA localization or becomes N³ for the three-dimensional TOA localization.

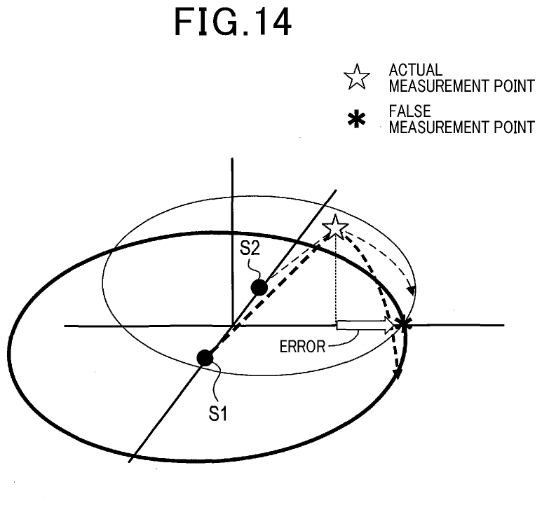

Let us consider, for the sake of the calculation process being simpler, a case where the two-dimensional TOA localization is carried out for reflection points that are three-dimensionally distributed. In this case, as illustrated in FIG. 14, the farther away the three-dimensional position of a selected reflection point from a two-dimensional reference plane on which the corresponding selected reflection point is projected, the larger an error between a detected distance of the corresponding selected reflection point and an actual distance thereof.

That is, although it is necessary to determine a location of the selected reflection point projected on the two-dimensional reference plane along an axis perpendicular to the two-dimensional reference plane, the selected reference is projected on the virtual sphere based on the measured distance about the first range sensor S1, so that the detected distance of the selected reflection point projected on the two-dimensional reference plane may be larger than an actual distance of the selected reflection point projected on the two-dimensional reference plane.

### First Embodiment

A three-dimensional positioning apparatus 1 according to the first embodiment of the present disclosure, which is installed in a vehicle, is configured to measure three-dimensional positions of target objects located around the vehicle.

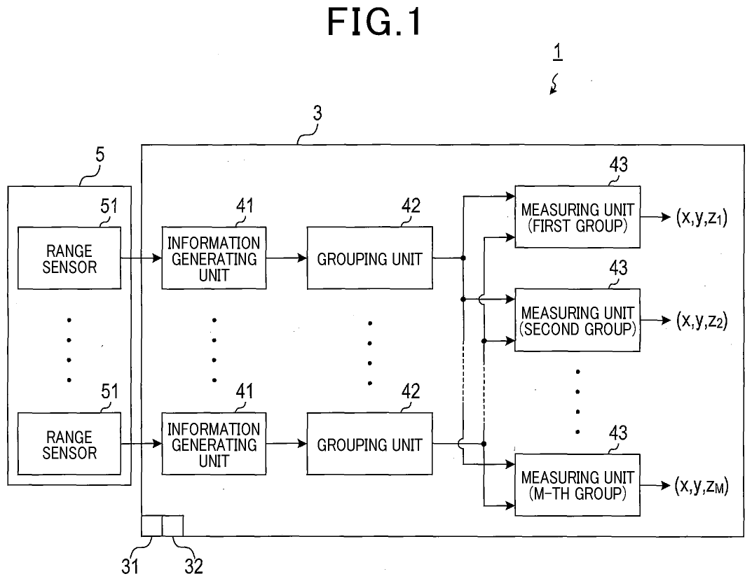

The three-dimensional positioning apparatus 1 includes, as illustrated in FIG. 1, a signal processing unit 3. The three-dimensional positioning apparatus 1 can include a sensor unit 5.

The sensor unit 5 includes a plurality of range sensors 51. Each range sensor 51 is comprised of a radio-wave radar that emits a radio wave signal as a probe wave signal. The range sensors 51 have the same configuration, and each range sensor 51 is comprised of antennas aligned in a predetermined first direction with respectively different positions in the first direction. Each range sensor 51 is not limited to such a radio-wave radar, and can be comprised of a light detection and ranging device (LIDAR) that emits a light wave signal as a probe wave signal or a sound navigation and ranging device (SONAR) that emits an ultrasonic wave signal as a probe wave signal.

The vehicle has a longitudinal direction thereof, a width direction thereof, and a height direction, i.e., a vertical direction, thereof. The longitudinal direction of the vehicle is defined as a direction of an X-axis (X-axis direction), the width direction of the vehicle is defined as a direction of a Y axis (Y-axis direction), and the height direction of the vehicle is defined as a direction of a Z axis (Z-axis direction). The X and Y axes define an X-Y plane that is parallel to the horizontal.

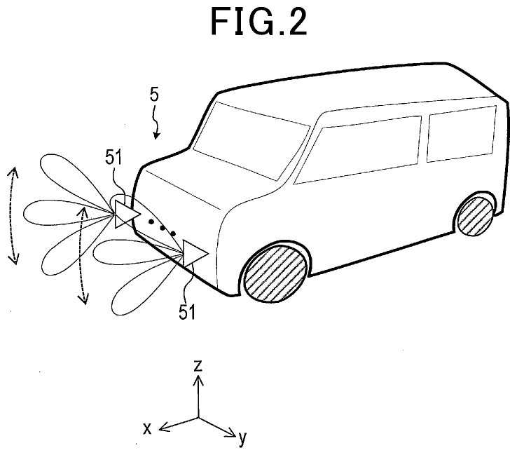

The range sensors 51 of the sensor unit 5 are, as illustrated in FIG. 2, mounted to a front bumper, which is attached to the front of the vehicle, or to the front of the vehicle located adjacent to the front bumper while being aligned in the Y-axis direction. Each of the range sensors 51 has a predetermined bore sight direction that represents the direction of emitting a probe wave signal therefrom; the bore sight direction of each range sensor 51 is determined to agree with the X-axis direction, and the first direction in which the antennas of the respective range sensors 51 are aligned is determined to agree with the Z-axis direction.

Specifically, each range sensor 51 of the sensor unit 5 is arranged to measure an angle θv of an arrival direction of each echo in an X-Z plane defined by the X and Z axes to the bore sight direction; the angle θv of the arrival direction of each echo to the bore sight direction will be referred to as a vertical azimuth or vertical angle θv. The Y-axis direction is defined as a second direction according to the first embodiment, and the X-Z plane is defined as a first plane according to the first embodiment.

The bore sight direction of each range sensor 51 for example represents a direction in which an emission energy pattern of a probe wave signal emitted from the corresponding range sensor 51 has a maximum intensity level or a center direction of an emission range of a probe wave signal transmitted from the corresponding range sensor 51.

The signal processing unit 3 includes a microcomputer that is comprised of a CPU 31 and a semiconductor memory, which will be referred to simply as a memory 32, such as a RAM, ROM, and/or a flash memory. The signal processing unit 3 includes information generating units 41, grouping units 42, and measuring units 43. The CPU 31 of the processing unit 3 carries out programs stored in the memory 32 to thereby implement the above functional elements 41, 42, and 43.

The information generating units 41 are provided for the respective range sensors 51 included in the sensor unit 5, and the grouping units 42 are similarly provided for the respective range sensors 51. This results in plural pairs of information generating units 41 and grouping units 42 being provided; each pair of information generating unit 41 and grouping unit 42 corresponds to one of the range sensors 51. The information generating unit 41 and the grouping unit 42 of each pair perform the same operations.

Each information generating unit 41, which is provided for the corresponding range sensor 51, is configured to receive measurement signals that are received through the antennas of the corresponding range sensor 51 and sent thereto from the corresponding range sensor 51.

Each information generating unit 41 is also configured to perform, based on the obtained measurement signals, a filtering process, a peak extracting process, and an azimuth measuring process to thereby generate a set of reflection-point information items, each of which includes at least

1. A distance R between the corresponding range sensor 41 and a corresponding reflection point that has reflected a corresponding probe wave signal emitted from the corresponding range sensor 41

2. A vertical azimuth θv representing an azimuth of the corresponding reflection point in the first plane when the corresponding reflection point is viewed from the corresponding range sensor 41

Each of the reflection-point information items generated by the information generating unit 41 provided for each range sensor 51 can additionally include

1. A relative speed between the corresponding range sensor 51 and the corresponding reflection point that has reflected the corresponding probe wave signal emitted from the corresponding range sensor 51

2. A received intensity of a reflection wave signal (echo) resulting from reflection of the corresponding probe wave signal by the corresponding reflection point

Specifically, each information generating unit 41 measures a time duration between the emitting of a corresponding probe wave signal and the receiving of a reflection wave signal (echo) resulting from reflection of the emitted probe wave signal from a corresponding reflection point, and converts the measured time into a distance R between the corresponding information generating unit 41 and the corresponding reflection point.

For example, each information generating unit 41 can calculate the vertical azimuth θv of each reflection point in accordance with phase differences between the measurement signals, which correspond to the reflection point, received through the respective antennas of the corresponding range sensor 51. As another example, each information generating unit 41 can calculate the vertical azimuth θv of each reflection point in accordance with a two-dimensional trilateration localization based on distances between the corresponding information generating unit 41 and the corresponding reflection point; the distances are based on the measurement signals received through the respective antennas of the corresponding range sensor 51.

Each grouping unit 42, which is provided for the corresponding range sensor 51 and the corresponding information generating unit 41, is configured to perform a grouping task that separates, based on the vertical azimuths θv of the reflection points included in the respective reflection-point information items, the corresponding reflection points into M groups where M is an integer more than or equal to 2.

In particular, each grouping unit 42 according to the first embodiment separates a usable angular range around the bore sight direction of the corresponding range sensor 51 in the X-Z plane into five groups as an example of M groups; the usable angular range around the bore sight direction of the corresponding range sensor 51 in the X-Z plane is defined such that (i) the bore sight direction of the corresponding range sensor 51 is set to 0 degrees, (ii) an elevational angular-range limit relative to the bore sight direction is defined as a positive angular range from 0 degrees exclusive to +10 degrees inclusive, and (iii) a depression angular-range limit relative to the bore sight direction is defined as a negative angular range from 0 degrees exclusive to −10 degrees inclusive.

That is, the usable angular range is defined as an angular range from −10 degrees to +10 degrees inclusive.

For example, each grouping unit 42 according to the first embodiment separates the usable angular range around the bore sight direction of the corresponding range sensor 51 in the X-Z plane into five angular ranges that include

1. The first angular range is defined from −10 degrees inclusive to −7 degrees exclusive

2. The second angular range is defined from −7 degrees inclusive to −3 degrees exclusive

3. The third angular range is defined from −3 degrees inclusive to +3 degrees inclusive

4. The fourth angular range is defined from +3 degrees exclusive to +7 degrees inclusive

5. The fifth angular range is defined from +7 degrees exclusive to +10 degrees inclusive

That is, each grouping unit 42 according to the first embodiment separates, based on the vertical azimuths θv of the reflection points included in the respective reflection-point information items, the corresponding reflection points into

1. The first group of one or more reflection points that are included in the first angular range

2. The second group of one or more reflection points that are included in the second angular range

3. The third group of one or more reflection points that are included in the third angular range

4. The fourth group of one or more reflection points that are included in the fourth angular range

5. The fifth group of one or more reflection points that are included in the fifth angular range

Each grouping unit 42 according to the first embodiment can be configured to eliminate, from the reflection points included in the respective reflection-point information items, one or more reflection points whose vertical azimuths θv are located outside the usable angular range from −10 degrees to +10 degrees inclusive as unnecessary reflection points.

The number of measuring units 43 corresponds to the number of groups separated by each grouping unit 42, i.e., the M measuring units 43, i.e., the five measuring units 43 corresponding to the five groups separated by each grouping unit 42 are provided.

Each of the measuring units 43, which is provided for a corresponding one of the first to fifth groups, is configured to perform a distance measurement task based on one or more reflection-point information items on the one or more reflection points belonging to the corresponding one of the first to fifth groups. In particular, each of the measuring units 43, which is provided for a corresponding one of the first to fifth groups, is configured to perform the two-dimensional TOA localization as the distance measurement task.

Specifically, the two-dimensional TOA localization for each of the first to fifth groups performed by a corresponding one of the measuring units 43 obtains a reference axis that represents a center axis of a corresponding one of the first to fifth angular ranges; the center axis has an angle to the bore sight direction. Next, the two-dimensional TOA localization for each of the first to fifth groups performed by a corresponding one of the measuring units 43 establishes a group reference plane defined by the reference axis of the corresponding one of the first to fifth angular ranges and the Y axis.

Then, the two-dimensional TOA localization for each of the first to fifth groups performed by a corresponding one of the measuring units 43 calculates, in a corresponding one of the group reference planes, a two-dimensional location of each reflection point included in the corresponding one of the first to fifth groups. The group reference planes for the respective first to fifth groups correspond respectively to second planes.

The two-dimensional location of each reflection point in each of the group reference plane is represented as an x-axis coordinate in the X-axis and a y-axis coordinate in the Y axis in the corresponding one of the group reference planes, which will be referred to as two-dimensional coordinates (x, y) in the corresponding one of the group reference planes.

Each of the measuring units 43, which is provided for a corresponding one of the first to fifth groups, can be configured to perform another task of calculating a two-dimensional location of each reflection point included in the corresponding one of the first to fifth groups except for the two-dimensional TOA localization.

Each of the measuring units 43, which is provided for a corresponding one of the first to fifth groups, is configured to combine the two-dimensional coordinates (x, y) of each reflection point included in the corresponding one of the first to fifth groups in the corresponding one of the group reference planes with a coordinate of the corresponding one of the group reference planes in the Z axis as a z-axis coordinate of the corresponding reflection point. This calculates three-dimensional coordinates (x, y, z) of each reflection point included in each of the first to fifth groups.

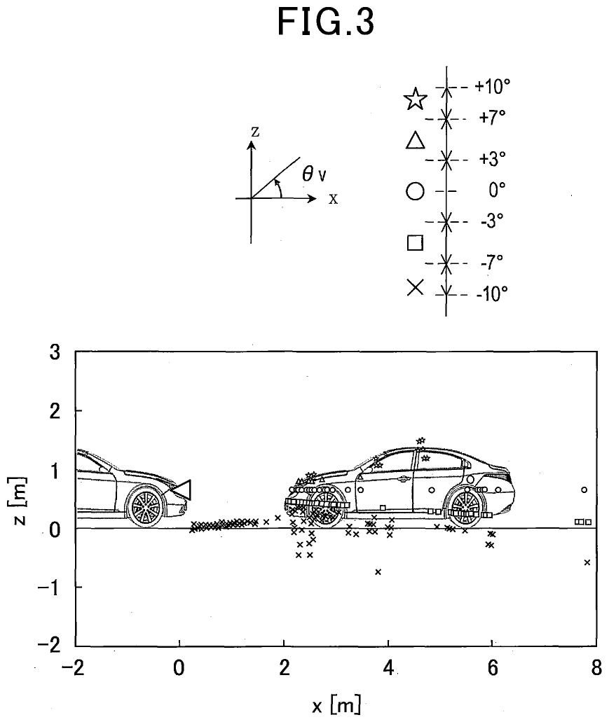

FIG. 3 is a graphical diagram illustrating the reflection points, which are based on the respective reflection-point information items generated by each of the information generating units 41, being plotted on the X-Z plane. Specifically, the reflection points included in each of the first to fifth groups are plotted on the X-Z plane using uniquely shaped dots, so that the shape of the dot of each reflection point included in each of the first to fifth groups is different from that of the dot of each reflection point included in another of the first to fifth groups.

Note that FIG. 3 illustrates reflection points whose vertical azimuths θv are farther away from the bore sight direction than −10 degrees of the first angular range, and also illustrates reflection points whose vertical azimuths θv are farther away from the bore sight direction than +10 degrees of the fifth angular range.

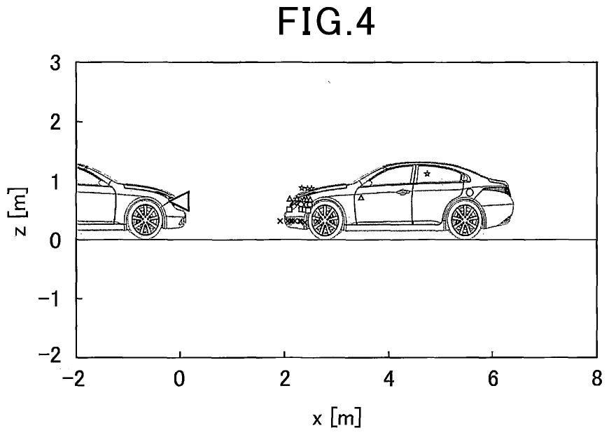

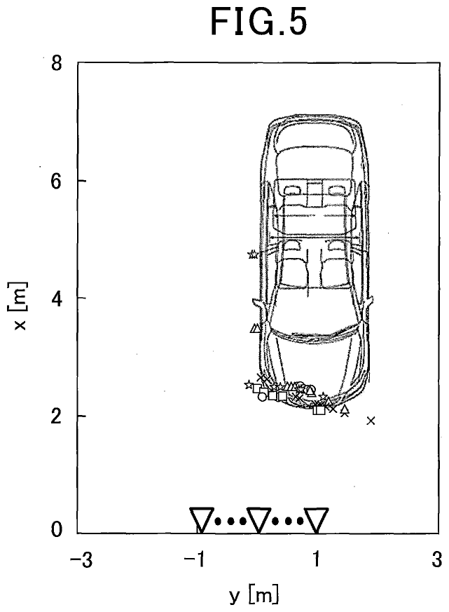

FIG. 4 illustrates how the reflection points included in each of the first to fifth groups, which are subjected to the two-dimensional TOA localization for the corresponding one of the first to fifth groups, are distributed in the X-Z plane. Similarly, FIG. 5 illustrates how the reflection points included in each of the first to fifth groups, which are subjected to the two-dimensional TOA localization for the corresponding one of the first to fifth groups, are distributed in the X-Y plane.

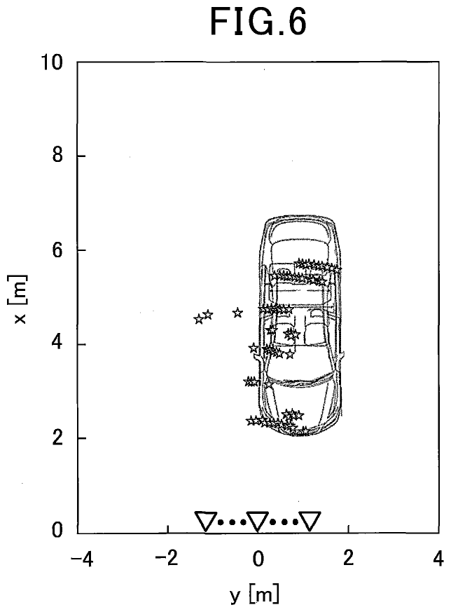

In contrast, FIG. 6 illustrates how all the reflection points, which are subjected to the two-dimensional TOA localization without being grouped according to a comparative example, are distributed in the X-Z plane.

As illustrated in FIGS. 4 and 5, the three-dimensional positioning apparatus 1 measures the actual reflection points located on the front of a target object, i.e., a target vehicle. In contrast, as illustrated in FIG. 6, the comparative example results in, in addition to the actual reflection points located on the front of the target vehicle, many false reflection points, i.e., many ghost reflection points, located inside of the target vehicle.

The reason why the many ghost reflection points are detected by the comparative example is as follows.

Specifically, as illustrated in FIG. 3, reflection points located close to the tires of the target vehicle, which belong to the fifth group for the first embodiment, are considerably far away from a single reference plane, i.e., an X-Y plane, based on the bore sight direction. Similarly, reflection points located close to the roof of the target vehicle, which belong to the first group for the first embodiment, are considerably far away from the single reference plane based on the bore sight direction.

That is, the positions of these faraway reflection points projected on the single reference plane may be farther away from actual projection positions of these faraway reflection points on the single reference plane. This may result in the faraway reflection points being measured as ghost reflection points located inside the target vehicle as illustrated in FIG. 6.

The three-dimensional positioning apparatus 1 according to the first embodiment achieves the following advantageous benefits.

The three-dimensional positioning apparatus 1 is configured to categorize the probe-wave reflection points into a predetermined number of groups within a predetermined angular range in the vertical direction, and perform, for each of the groups, the two-dimensional TOA localization based on one or more probe-wave reflection points included in the corresponding one of the groups.

The above configuration of the three-dimensional positioning apparatus 1 results in the number of reflection points included in each of the groups, which are subjected to the two-dimensional TOA localization, being reduced, resulting in the number of measurement points represented by the number of combinations of the reflection points included in each of the groups being reduced. The above configuration therefore makes it possible to reduce a calculation time required to calculate the three-dimensional positions of all the reflection points according to the first embodiment as compared with a calculation time required to calculate the three-dimensional positions of all the reflection points collectively without being grouped.

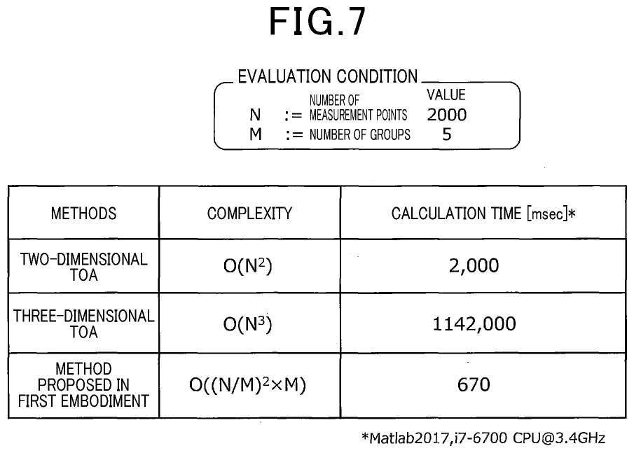

FIG. 7 illustrates

1. A first result of a calculation time required to calculate the two-dimensional location of each of 2000 measurement points using the two-dimensional TOA localization

2. A second result of a calculation time required to calculate the three-dimensional location of each of the 2000 measurement points using the three-dimensional TOA localization

3. A third result of a calculation time required for the three-dimensional positioning apparatus 1 to calculate the three-dimensional location of each of the 2000 measurement points

The calculation time required to calculate the two-dimensional location of each of N measurement points using the two-dimensional TOA localization can be expressed as a function of O(N²), and the calculation time required to calculate the three-dimensional location of each of the N measurement points using the three-dimensional TOA localization can be expressed as a function of O(N³).

In contrast, the calculation time required for the three-dimensional positioning apparatus 1 to calculate the three-dimensional location of each of the N measurement points can be expressed as a function of O ((N/M)²×M).

Actually, the calculation time required for the three-dimensional positioning apparatus 1 to calculate the three-dimensional location of each of the N measurement points was calculated on the assumption that

1. An average calculation time required for the three-dimensional positioning apparatus 1 to calculate the reflection points included in each of the groups is 79.4 milliseconds

2. The sum of a time required for the three-dimensional positioning apparatus 1 to measure the vertical azimuths of all the reflection points is 170 milliseconds

FIG. 7 shows that the calculation time for the three-dimensional positioning apparatus 1 is reduced to be approximately 1/1700 of that for the three-dimensional TOA localization, and approximately one-third (⅓) of that for the two-dimensional TOA localization. In addition, the three-dimensional positioning apparatus 1 makes it possible to measure the three-dimensional location of each of the reflection points with higher accuracy than that measured by the two-dimensional TOA localization.

As described above, the three-dimensional positioning apparatus 1 is configured to categorize the probe-wave reflection points into a predetermined number of groups within the predetermined angular range in the vertical direction.

This configuration therefore enables the reflection points included in each of the groups to respectively have smaller differences from the group reference plane of the corresponding one of the groups in the vertical direction. The three-dimensional positioning apparatus 1 accordingly results in a smaller error of the three-dimensional location of each of the three-dimensionally distributed reflection points due to execution of the two-dimensional TOA localization for the three-dimensionally distributed reflection points.

The three-dimensional positioning apparatus 1 is configured to measure the location of each of the reflection points in the vertical direction with a relatively less-strict resolution of the corresponding one of the angular ranges in which the corresponding one of the reflection points is included.

Specifically, the target-object recognition control of the position of a target object in the height direction of an own vehicle is enough to

1. Determine whether the own vehicle can pass under the target object if the target object is a superjacent object, or

2. Determine whether the own vehicle can pass over the target object if the target object is a subjacent object

The target-object recognition control of the position of a target object in the height direction of an own vehicle therefore permits measurement of the position of the target object in the vertical direction with a relatively lower accuracy as compared with an accuracy required for measurement of the position of the target object in a horizontal plane.

For this reason, the three-dimensional positioning apparatus 1, which measures the location of each of the reflection points in the vertical direction with the relatively less-strict resolution, reduces the throughput of calculating the location of the corresponding one of the reflection points, thus achieving both

1. Improvement of real-time calculation of the three-dimensional position of the corresponding one of the reflection points

2. Measurement of the three-dimensional position of the corresponding one of the reflection points with necessary and sufficient accuracy

### Second Embodiment

The following describes the second embodiment. Because the basic configuration of the second embodiment is identical to that of the first embodiment, the following describes the points of the second embodiment, which are different from the first embodiment. Reference characters respectively assigned to components of the first embodiment are used to refer to the identical components of the second embodiment, which are substantially identical to the respective components of the first embodiment.

The location of a sensor unit 5a of a three-dimensional positioning apparatus 1a according to the second embodiment is different from that of the sensor unit 5 according to the first embodiment. In addition, the second embodiment uses virtual range sensors for generating reflection-point information items, which is a point different from the first embodiment.

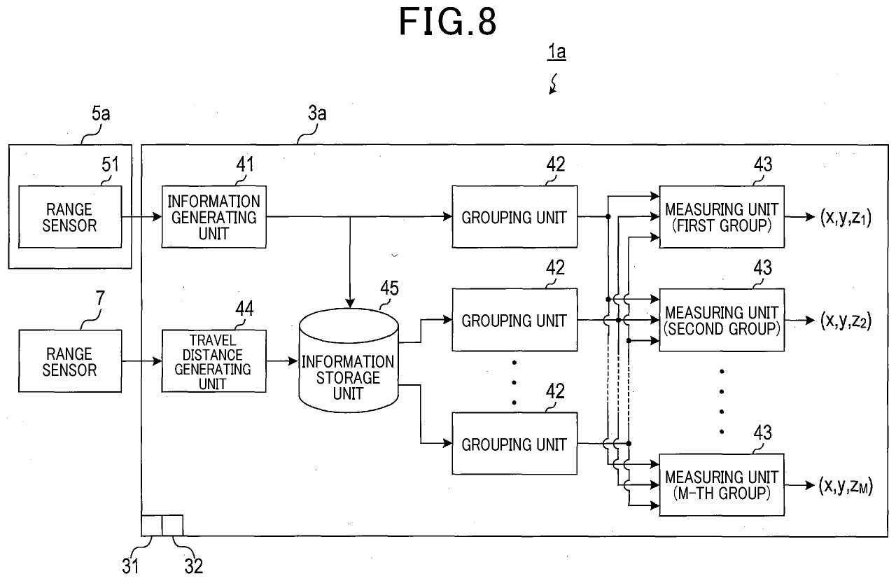

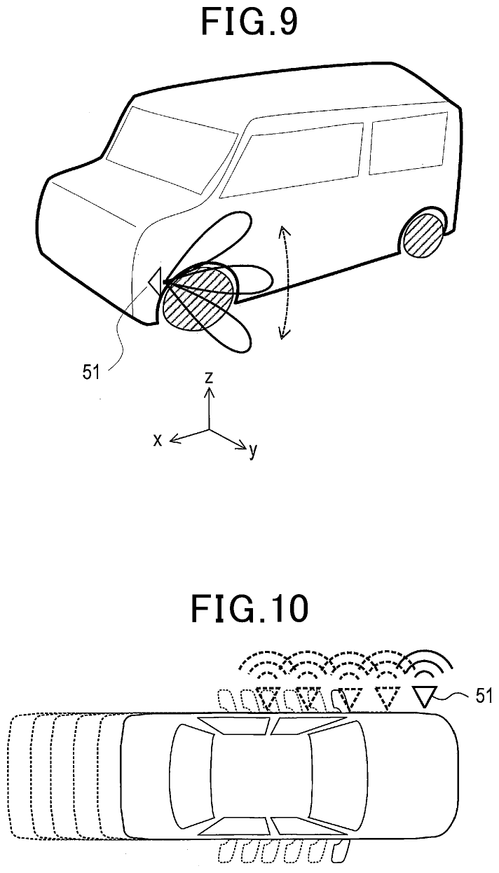

The three-dimensional positioning apparatus 1a includes, as illustrated in FIG. 8, a signal processing unit 3a, the sensor unit 5a, and a behavior sensor 7.

The sensor unit 5a includes a single range sensor 51. The sensor unit 5a is mounted to one side of the vehicle such that

1. The bore sight direction of the range sensor 51 extends in the direction, i.e., the Y-axis direction, that is perpendicular to the traveling direction of the vehicle, i.e., a mobile object, and is parallel to the horizontal

2. The first direction matches the Z-axis direction

That is, the sensor unit 5a is arranged to measure an angle of an arrival direction of each echo in a Y-Z plane defined by the Y and Z axes. The Y-Z plane is defined as the first plane according to the second embodiment.

The behavior sensor 7 is comprised of at least one sensor for measuring travel-distance information required to calculate both the amount of movement, i.e., the travel distance, of the vehicle and the travel direction of the vehicle. For example, the behavior sensor 7 is comprised of, for example, a vehicle speed sensor, a steering angle sensor, an acceleration sensor, and/or a yaw rate sensor.

The signal processing unit 3a includes the microcomputer that is comprised of the CPU 31 and the semiconductor memory, i.e., memory, 32, such as a RAM, ROM, and/or a flash memory.

The signal processing unit 3a includes, in addition to the single information generating unit 41, the grouping units 42, and the measuring units 43, a travel distance generating unit 44 and an information storage unit 45. The CPU 31 of the processing unit 3a carries out programs stored in the memory 32 to thereby implement the above functional elements 41, 42, 43, 44, and 45.

The single information generating unit 41 is provided for the single range sensor 51.

The travel distance generating unit 44 is configured to perform successive measurement cycles, each of which obtains, at the corresponding current measurement cycle, the travel-distance information from the behavior sensor, and calculates, at the corresponding current measurement cycle, a travel-distance information item that includes

1. A distance that the vehicle has traveled for a time from an immediately previous measurement cycle to the corresponding current measurement cycle

2. A direction of the travel of the vehicle

The travel distance generating unit 44 can be configured to obtain the travel-distanced information from the behavior sensor 7 via a communication network installed in the vehicle, such as a controller area network (CAN®).

The information generating unit 41 is configured to perform the azimuth measuring process for each measurement cycle to thereby generate a reflection-point measurement comprised of the reflection-point information items.

The information storage unit 45 is configured to store the reflection-point measurement generated by the information generating unit 41 for each measurement cycle and the travel-distance information item calculated by the travel distance generating unit 44 for each measurement cycle such that the reflection-point measurement for the corresponding measurement cycle and the travel-distance information item for the corresponding measurement cycle are correlated with each other.

A combination of the reflection-point measurement and the travel-distance information item stored in the information storage unit 45 for each measurement cycle will be referred to as a reflection-point information set.

In particular, the information storage unit 45 is configured to eliminate the reflection-point information set, which has been stored for the length of, for example, the last (P+1) measurement cycles, so that the last P reflection-point information sets for the last P measurement cycles are always stored in the information string unit 45.

The grouping units 42 are provided for the respective last P reflection-point information sets stored in the information storage unit 45, so that the number of grouping units 42 is set to P.

Each grouping unit 42, which is provided for the respective last P reflection-point information sets stored in the information storage unit 45, is configured to perform, like the first embodiment, the grouping task that separates, based on the angles of the arrival directions of the reflection points included in the respective reflection-point information items, the corresponding reflection points into the M groups.

The number of measuring units 43 corresponds to the number of groups separated by each grouping unit 42, i.e., the M measuring units 43.

Each of the measuring units 43, which is provided for a corresponding one of the M groups, is configured to perform, like the first embodiment, the distance measurement task based on one or more reflection-point information items on the one or more reflection points belonging to the corresponding one of the M groups.

The following describes how the three-dimensional positioning apparatus 1a works.

The reflection-point measurement, i.e., the reflection-point information items, generated by the information generating unit 41 for each measurement cycle and the travel-distance information item generated by the behavior sensor 7 for each measurement cycle are stored in the information storage unit 45 such that the reflection-point measurement for the corresponding measurement cycle and the travel-distance information item for the corresponding measurement cycle are correlated with each other.

When the vehicle is travelling, the range sensor 51 performs, as illustrated in FIG. 10, the azimuth measuring process for each of the measurement cycles at a corresponding one of different positions in the traveling direction of the vehicle; the internal between each adjacent pair of the different positions represents a corresponding one of the travel distances of the vehicle.

For this reason, the reflection-point measurement for each of the measurement cycles stored in the information storage unit 45 can be regarded as a measurement result of a corresponding one of virtual range sensors that are located at the respective different positions in the traveling direction of the vehicle.

As described above, the range sensors 51 according to the first embodiment, which are used for the two-dimensional TOA localization, are arranged in the first direction with predetermined intervals.

In contrast, the second embodiment is configured to calculate the position of each of the virtual range sensors, which respectively correspond to the previous reflection-point measurements stored in the information storage unit 45, relative to the current position of the single range sensor 51 in accordance with the travel-distance information items correlated with the respective reflection-point measurements. Each of the positions of the respective virtual range sensors shows the position of the single range sensor 51 that measured a corresponding one of the reflection-point measurements.

This enables the arrangement intervals among the plural range sensors, which include the single range sensor 51 and (P−1) virtual range sensors, to be determined.

The other operations of the three-dimensional positioning apparatus 1a are substantially identical to those of the three-dimensional positioning apparatus 1 according to the first embodiment.

The three-dimensional positioning apparatus 1a according to the second embodiment set forth above achieves the following advantageous benefit in addition to the advantageous benefits achieved by the three-dimensional positioning apparatus 1 according to the first embodiment.

The three-dimensional positioning apparatus 1a calculates the three-dimensional positions of all the reflection points of a target object located in the vehicle width direction using the single range sensor 51. This enables the three-dimensional positioning apparatus 1a to have a more simplified configuration.

### Third Embodiment

The following describes the third embodiment. Because the basic configuration of the third embodiment is identical to that of the first embodiment, the following describes the points of the third embodiment, which are different from the first embodiment. Reference characters respectively assigned to components of the first embodiment are used to refer to the identical components of the third embodiment, which are substantially identical to the respective components of the first embodiment.

The configuration of each grouping unit 42a according to the third embodiment is different from that of the corresponding grouping unit 42 according to the first embodiment.

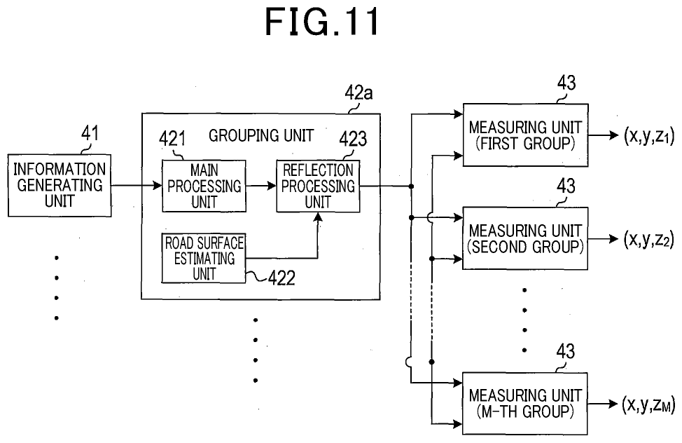

Each grouping unit 42a includes, as illustrated in FIG. 11, a main processing unit 421, a road surface estimator 422, a reflection processing unit 423. The road surface estimator 422 serves as a reflection surface estimator.

The main processing unit 421 of each grouping unit 42a, which is provided for the corresponding range sensor 51 and the corresponding information generating unit 41, is configured to perform the grouping task that is the same as the grouping task performed by the corresponding grouping unit 42 according to the first embodiment.

The road surface estimator 422 of each grouping unit 42a is configured to estimate, based on information of the mount position of the corresponding range sensor 51, the position of a road surface in the Z-axis direction; the road surface serves as a reflection surface that reflects probe wave signals.

The reflection processing unit 423 of each grouping unit 42a is configured to

1. Determine that at least one selected reflection point included in the first to third groups, the position in the Z-axis direction of which is located to be lower than the position of the road surface in the Z-axis direction estimated by the road surface estimator 422, is a false reflection point based on road-surface reflection

2. Eliminate the at least one selected reflection point from at least one of the first to third groups in which the at least one reflection point is included

Note that the position of the at least one selected reflection point can be calculated based on the vertical azimuth θv and the distance R of the at least one selected reflection point.

In place of the elimination, the reflection processing unit 423 can be configured to treat the at least one selected reflection point as at least one symmetric reflection point whose position in the Z-axis direction is located to be symmetrical to the position of the at least one selected reflection point in the Z-axis direction with respect to the estimated road surface, thus changing the current group of the at least one selected reflection point into another proper group in which the at least one symmetric reflection point is included.

The third embodiment describes an example where the grouping units 42a are applied to the three-dimensional positioning apparatus 1 of the first embodiment, but the present disclosure is not limited thereto. Specifically, the grouping units 42a can be applied to the three-dimensional positioning apparatus 1a of the second embodiment.

The three-dimensional positioning apparatus according to the third embodiment set forth above achieves the following advantageous benefit in addition to the advantageous benefits achieved by the three-dimensional positioning apparatus 1 according to the first embodiment.

The three-dimensional positioning apparatus of the third embodiment results in the three-dimensional positions of the reflection points calculated by each of the measuring units 43 with higher accuracy.

### Modifications

The present disclosure is not limited to the above embodiments described set forth above, and can be variously modified as follows.

Each of the first to third embodiments is configured such that the M angular ranges are set not to be overlapped with one another, but the present disclosure is not limited to this configuration.

Specifically, at least one adjacent pair of the M angular ranges can be partially overlapped with each other.

The present disclosure can be configured to variably determine the number of groups into which the reflection points are categorized in order to approximate the number of reflection points included in each of the groups to an average number of reflection points included in the corresponding one of the groups. Similarly, the present disclosure can be configured to variably determine a boundary between each adjacent pair of the M angular ranges in order to approximate the number of reflection points included in each of the groups to the average number of reflection points included in the corresponding one of the groups.

The closer the number of reflection points included in each of the groups to the average number of reflection points included in the corresponding one of the groups, the larger the reduction in the calculation time of the three-dimensional positions of all the reflection points.

The number of groups into which the reflection points are categorized can be determined based on how one or more software applications, which use the three-dimensional positions of all the reflection points measured by the three-dimensional positioning apparatus, require the accuracy of the position of each reflection point in the Z-axis direction, i.e., height direction.

Each of the first to third embodiments is configured to categorize the reflection points into the M groups based on the vertical azimuths θv of the respective reflection points, but the present disclosure is not limited to this configuration.

For example, the present disclosure can be configured to categorize the reflection points into the M groups based on the heights of the respective reflection points, i.e., the positions of the respective reflection points in the Z-axis direction.

The range of each group based on the vertical azimuths θv of the respective reflection points may be wider as one or more reflection points included in the range of the corresponding group is farther away from the corresponding range sensor. This may result in a larger error of the positions of such one or more faraway reflection points in the Z-axis direction obtained by the measuring units 43.

In contrast, the range of each group based on the heights of the respective reflection points is unchanged independently of the distance of each reflection point included in the corresponding group from the corresponding range sensor. This results in a smaller error of the positions of reflection points, especially, one or more faraway reflection points, in the Z-axis direction obtained by the measuring units 43. Note that the height of each reflection point can be calculated based on the distance R and the vertical azimuths θv included in the reflection-point information item on the corresponding reflection point.

The travel distance generating unit 44 of the third embodiment is configured to calculate the travel-distance information item in accordance with the travel-distance information obtained from the behavior sensor 7 via, for example, the communication network installed in the vehicle, but the present disclosure is not limited to this configuration.

For example, the travel distance generating unit 44 of the present disclosure can be configured to estimate a behavior of the vehicle based on selected reflection-point information items included in all the reflection-point information items obtained by the information generating units 41; the selected reflection-point information items represent one or more stationary objects, such as the road surface. In this modification, the sensor unit 5 doubles as the behavior sensor 7.

The second embodiment uses the single range sensor 51 included in the sensor unit 5a, but the present disclosure is not limited thereto. Specifically, the sensor unit 5a includes a plurality of range sensors 51.

The signal processing units 3 and 3a and methods performed by the signal processing units 3 and 3a described in the present disclosure can be implemented by a dedicated computer including a memory and a processor programmed to perform one or more functions embodied by one or more computer programs.

The signal processing units 3 and 3a and methods performed by the signal processing units 3 and 3a described in the present disclosure can also be implemented by a dedicated computer including a processor comprised of one or more dedicated hardware logic circuits.

The signal processing units 3 and 3a and methods performed by the signal processing units 3 and 3a described in the present disclosure can further be implemented by at least one dedicated computer comprised of a memory, a processor programmed to perform one or more functions embodied by one or more computer programs, and one or more hardware logic circuits.

The one or more computer programs can be stored in a non-transitory storage medium as instructions to be carried out by a computer. The one or more methods for implementing the function of each unit included in the signal processing units 3 and 3a do not need to include software, and therefore all functions included in the signal processing units 3 and 3a can be implemented by one or more hardware units.

The functions of one element in each embodiment can be distributed as plural elements, and the functions that plural elements have can be combined into one element. The functions of respective elements in each embodiment can be implemented by a single element, and the single function implemented by plural elements in each embodiment can be implemented by a single element. At least part of the structure of each embodiment can be eliminated. At least part of each embodiment can be added to the structure of another embodiment, or can be replaced with a corresponding part of another embodiment.

The present disclosure can be implemented by various embodiments in addition to the three-dimensional positioning apparatuses 1 and 1a; the various embodiments include systems each include the three-dimensional positioning apparatus 1 or 1a, programs for causing a computer to serve as the three-dimensional positioning apparatus 1 or 1a, non-volatile storage media, such as semiconductor memories, storing the programs, and three-dimensional positioning methods.

What is claimed is:

1. A three-dimensional positioning apparatus comprising:
an information generating unit configured to generate plural sets of reflection-point information items using at least one range sensor,
each of the reflection-point information items of each of the plural sets including:
a distance of a reflection point that reflects a probe wave signal emitted from the at least one range sensor, the distance being a distance of the reflection point from the at least one range sensor; and
an angle of the reflection point in a first plane, the angle of the reflection point representing an azimuth of the reflection point with respect to the at least one range sensor,
the first plane being defined by a first direction and a bore sight direction that represents a direction of the probe wave signal emitted from the at least one range sensor,
the first direction being perpendicular to the bore sight direction,
the plural sets of reflection-point information items being measured by the at least one range sensor at respectively different positions in a second direction that is perpendicular to the first direction;
a grouping unit configured to separate, into a plurality of groups, the reflection points included in the plural sets of reflection-point information items based on positional parameters of the respective reflection points in the first direction, each of the positional parameters of a corresponding one of the reflection points in the first direction representing a position of the corresponding one of the reflection points in the first direction; and
a measuring unit configured to perform a two-dimensional trilateration localization for each of the groups based on at least one reflection point included in a corresponding one of the groups to thereby calculate a location of the at least one reflection point included in each of the groups in a second plane, the second plane being defined by the second direction and a group center direction of the corresponding one of the groups, the group center direction of each group representing a center of the corresponding group in the first direction.

2. The three-dimensional positioning apparatus according to claim 1, wherein:
the information generating unit is configured to generate the plural sets of reflection-point information items respectively using a plurality of range sensors as the at least one range sensor, the plurality of range sensors being located at the respectively different positions in the second direction.

3. The three-dimensional positioning apparatus according to claim 1, further comprising:
the three-dimensional positioning apparatus further comprising:
a travel distance generating unit configured to perform successive measurement cycles, each of which obtains, at the corresponding measurement cycle, a travel-distance information item on a mobile object in which the at least one range sensor is installed, the travel-distance information item on the at least one range sensor for each of the successive measurement cycles including at least a distance that the at least one range sensor has traveled for a time from an immediately previous measurement cycle to the corresponding measurement cycle,
the information generating unit being configured to generate, for each of the successive measurement cycles, a corresponding one of the plural sets of reflection-point information items using the at least one range sensor; and
an information storage unit configured to store the plural sets of reflection-point information items and the travel-distance information items such that:
each of the plural sets of reflection-point information items generated for a corresponding one of the successive measurement cycles is correlated with a corresponding one of the travel-distance information items generated for the corresponding measurement cycle;
the at least one range sensor being arranged such that a travel direction of the mobile object matches the second direction,
the measuring unit being configured to treat the plural sets of reflection-point information items stored in the information storage unit for the respective successive measurement cycles as reflection-point measurements respectively measured by the at least one range sensor and virtual range sensors, a distance between each adjacent pair of the virtual range sensors representing the distance included in a corresponding one of the travel-distance information items.

4. The three-dimensional positioning apparatus according to claim 3, wherein:
a travel distance generating unit configured to perform each of the successive measurement cycles to thereby estimate, at the corresponding measurement cycle, the travel-distance information item in accordance with the plural sets of reflection-point information items generated by the information generating unit using the at least one range sensor.

5. The three-dimensional positioning apparatus according to claim 1, wherein:
the grouping unit is configured to use, as each of the positional parameters of the corresponding one of the reflection points in the first direction, an angle of an azimuth of the corresponding one of the reflection points in the first plane when the corresponding one of the reflection points is viewed from the at least one range sensor.

6. The three-dimensional positioning apparatus according to claim 1, wherein:
the grouping unit is configured to use, as each of the positional parameters of the corresponding one of the reflection points in the first direction, the position of the corresponding one of the reflection points in the first direction.

7. The three-dimensional positioning apparatus according to claim 1, wherein:
the grouping unit comprises:
a road surface estimator configured to estimate a position of a reflection surface that reflects the probe wave signal; and
a reflection processing unit configured to:
determine whether the reflection point represented by each of the reflection-point information items generated by the information generating unit is a false reflection point due to reflection of the probe wave signal by the reflection surface; and
perform, in response to determination that the reflection point represented by at least one of the reflection-point information items is a false reflection point, one of:
a first task of eliminating, from the reflection-point information items to be separated into the plurality of groups, the at least one reflection point, and
a second task of adding, to the reflection-point information items to be separated into the plurality of groups, the at least one reflection point as a symmetric reflection point whose position in the first direction is located to be symmetrical to the position of the at least one reflection point in the first direction with respect to the reflection surface.

8. A three-dimensional positioning method to be carried out by a computer, the three-dimensional positioning method comprising:
generating plural sets of reflection-point information items using at least one range sensor,
each of the reflection-point information items of each of the plural sets including:
a distance of a reflection point that reflects a probe wave signal emitted from the at least one range sensor, the distance being a distance of the reflection point from the at least one range sensor; and
an angle of the reflection point in a first plane, the angle of the reflection point representing an azimuth of the reflection point with respect to the at least one range sensor,
the first plane being defined by a first direction and a bore sight direction that represents a direction of the probe wave signal emitted from the at least one range sensor,
the first direction being perpendicular to the bore sight direction,
the plural sets of reflection-point information items being measured by the at least one range sensor at respectively different positions in a second direction that is perpendicular to the first direction;
separating, into a plurality of groups, the reflection points included in the plural sets of reflection-point information items based on positional parameters of the respective reflection points in the first direction, each of the positional parameters of a corresponding one of the reflection points in the first direction representing a position of the corresponding one of the reflection points in the first direction; and
performing a two-dimensional trilateration localization for each of the groups based on at least one reflection point included in a corresponding one of the groups to thereby calculate a location of the at least one reflection point included in each of the groups in a second plane, the second plane being defined by the second direction and a group center direction of the corresponding one of the groups, the group center direction of each group representing a center of the corresponding group in the first direction.
